(19) United States
(12) Patent Application Publication
(10) Pub. No.: US 2004/0143751 A1
(43) Pub. Date: Jul. 22, 2004

(54) Protection of embedded processing systems with a configurable, integrated, embedded firewall

(76) Inventor: Cyrus Peikari, Dallas, TX (US)

Correspondence Address: Cyrus Peikari, 6242 Walnut Hill Ln., Dallas, TX, 75230, US

(21) Appl. No.: 10/346,956

(22) Filed: Jan. 17, 2003

(51) Int. Cl. G06F 11/30

(52) U.S. Cl. 713/200

(57) ABSTRACT

The present invention provides a method and apparatus for increasing the security of data processing devices that use embedded operating systems (embedded devices). This invention utilizes an “embedded firewall” that improves security of the device by selectively filtering communication directly on the embedded device itself, rather than relying on an external firewall. In a preferred embodiment, this is achieved by (1) entering the desired filter specification at the user layer using an embedded user interface (UI) program or an imported specification file, (2) compiling the specification to be subsequently used by the embedded filtering engine, (3) Using an embedded dynamic link library (DLL) as an intermediary to isolate the user program from the lower kernel level, thus providing a system-independent interface, (4) communicating the specification to the kernel layer using the embedded DLL, (5) monitoring packets in the kernel level as they enter from the lower network level using an embedded packet driver, (6) filtering packets at the kernel level using the embedded filtering engine and the previously defined filter specification, (7) reporting the results from the kernel level back up to the user level through the embedded DLL.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The invention relates to the protection of data processing systems. In particular, the invention is directed to increasing the security of embedded computer systems, especially those that use wireless communication.

### BACKGROUND OF THE INVENTION

The most common method for protecting traditional computer systems from malicious attackers (such as hackers and hostile code) is to use a firewall. This method involves monitoring some or all inbound and/or outbound communication from the device. For example, a traditional computer server or workstation may use a software program known as a “personal firewall” to monitor and selectively block hostile probes or attacks from the outside network. Such a firewall can also block attacks from within, such as outbound communication from a “Trojan horse”, which can give a remote hacker control of a computer system.

When a typical firewall detects inbound or outbound communication that is not explicitly permitted, then it is able to selectively filter out the unwanted or dangerous communication packets of data streaming in from the outside network, such as from a local area network or from the Internet. This selective filtering allows the firewall to protect the host computer from certain kinds of attacks, such as hacker probes or Trojan horses.

The number of small and miniature devices that utilize operating systems is rapidly growing. Because of special design constraints, such smaller devices require a special type of operating system known as an “embedded operating system.” These so called “embedded devices” include personal data assistants, handheld computers, “smart” cellular phones (smartphones) and even watches, cameras and toasters. These tiny embedded devices can each now have their own embedded operating systems. However, as these embedded devices increase in sophistication and features, they offer increased vulnerability to attack.

In addition, many of these small, embedded devices such as smartphones and PDAs include novel communication protocols such as wireless (radio-frequency) communication. Because of this enhanced wireless ability, these devices communicate through the air at a distance and can be remote-controlled, often by malicious attackers who “hack” into the communication protocols. For example, a hacker parked in a car down the street could theoretically control an unprotected, embedded toaster using radio frequency communication, thus maliciously causing the remote toaster to overheat and set fire to a house. Thus, there is a growing need for novel solutions to protect these vulnerable embedded devices.

Prior to the present invention, firewalls did not exist that operate directly on the embedded device itself. Firewalls have traditionally served to protect computers on a wired network such as a corporate local area network. For example, Check Point™ Software Technologies, Inc. makes enterprise firewalls that protect data traversing a network such as a wired corporate local area network. In addition, Symmantec™ Corp. makes a software “personal firewall” product that runs on computers with traditional (i.e., non-embedded) operating systems. Similarly, 3Com® Corp. makes network interface cards (NICs) that have a firewall embedded directly on to the NIC.

However, none of the above prior art examples works directly within computer processing systems that use embedded operating systems (“embedded devices”). Thus, the prior art does not directly protect the embedded device itself from attacks. In contrast, the present invention improves upon the prior art by integrating directly with the embedded operating system and by providing protection directly on the embedded device itself.

For example, malicious code has already been created that attacks embedded devices such as cellular phones. An example is the Visual Basic Script (VBS)-based “Timofonica” Trojan horse virus that hit a wireless network in Madrid, Spain. Timofonica appends and spreads itself through email contact lists. With Timofonica, each future e-mail sends out a copy of the Trojan horse also sends an SMS (short messaging service) message across the GSM (global system for mobile communications) phone network to randomly generated addresses at a particular Internet host server. This can create annoying SMS spamming, or even a denial of service condition. Not having an embedded firewall, the cellular phones of prior art have so far been unprotected.

Similarly, a Norwegian company found another example of malicious code. In this case, a Norway-based WAP (wireless application protocol) service developer known as Web2WAP was testing its software on Nokia phones. During the testing, they found that a certain SMS was freezing phones that received it. The code knocked out the keypad for up to a minute after the SMS was received. This is similar to format attacks that cause crashes or denial of service attacks against Internet servers.

As explained above, prior art firewalls are limited to protecting only those computing systems using standard operating systems. Because of the widespread and growing use of embedded devices and wireless networking, there is now a glaring gap in the security of these computing devices and their associated networks. For example, if an embedded device is hacked, more damage can be done than just to the device itself. Because embedded devices such as PDAs and smartphones often connect to a wired network such as a company local area network or the wired Internet, a hacked PDA can become a launching pad for attacks against the entire network. In this way, the embedded device becomes the “Achilles heel” weakness that brings about compromise of the entire network.

Currently, the prior art has no provision for protecting devices with embedded operating systems (for example, cellular phones and Internet-enabled appliances) with an embedded firewall. At the present time, traditional firewalls are commonplace, with hundreds of millions in use each day. In addition, embedded devices are commonplace, with hundreds of millions in use each day.

However, despite the widespread use of these prior art technologies and the long felt need for such protection, there has never been a successful “embedded firewall” solution until the present method and apparatus. This is because it takes an intuitive leap of invention to overcome the technological hurdles which have, until now, proved serious barriers to creating an embedded firewall in the prior art.

In fact, there are several significant technological obstacles to overcome before a successful embedded firewall can be created. Embedded operating systems place severe design constraints on developers. These constraints include a restricted API (application program interface), a restricted driver development environment, and a limited amount of memory and storage space for design. In addition, solutions for embedded operating systems must be able to support a greatly increased number of wireless communication protocols, and they must also be able to operate in a platform-independent manner. The present invention overcomes these restraints that have limited the prior art.

### BRIEF SUMMARY OF THE INVENTION

The present invention overcomes the disadvantages of the prior art, by offering the following:

In a first embodiment, the present invention provides a method and apparatus for protecting embedded devices by using an embedded firewall that runs directly on the embedded device itself. This improves the level of protection for the embedded device by selectively filtering malicious or unauthorized communication into or out of the device.

In a second embodiment, the present invention provides a method and apparatus for protecting embedded devices by using an embedded firewall that is specially designed to run on an embedded operating system by overcoming the design challenges of a restricted API, a restricted driver development environment, a limited amount of system resources, a need to support numerous wireless networking protocols and a need to operate in a platform-independent manner.

In a third embodiment, the present invention provides a system for improving the protection of embedded devices by adding a layer of protection (i.e., an embedded firewall) directly within the embedded device itself.

In a fourth embodiment, the present invention provides a method and apparatus for protecting the embedded device by selectively filtering communication into and out of the device. The embedded nature of the invention allows the firewall to work directly on the embedded device itself, thus providing greatly improved protection for the embedded device.

Each of these embodiments can be achieved by the following preferred system for: a) entering the desired filter specification at the user layer using an embedded user interface (UI) program or an imported specification file, (b) compiling the specification to be subsequently used by the embedded filtering engine, (c) using an embedded dynamic link library (DLL) as an intermediary to isolate the user program from the lower kernel level, thus providing a system-independent interface, (d) communicating the specification to the kernel layer using the embedded DLL, (e) monitoring packets in the kernel level as they enter from the lower network level using an embedded packet driver, (f) filtering packets at the kernel level using the embedded filtering engine and the previously defined filter specification, (g) reporting the results from the kernel level back up to the user level through the embedded DLL.

### BRIEF DESCRIPTION OF THE DRAWINGS

The present invention may be understood more clearly from the following detailed description, which is solely for explanation and should not be taken to limit the invention to any specific form thereof, taken together with the accompanying drawings, wherein:

FIG. 1 is a block diagram of an embedded processing system employing the protection capabilities of the present invention.

FIG. 2 is a flow diagram illustrating an embodiment of the present invention, which protects the embedded processing system by selective filtering data communication on the embedded device.

### DETAILED DESCRIPTION OF THE INVENTION

The operation of the present invention will now be described in conjunction with the Drawing Figures.

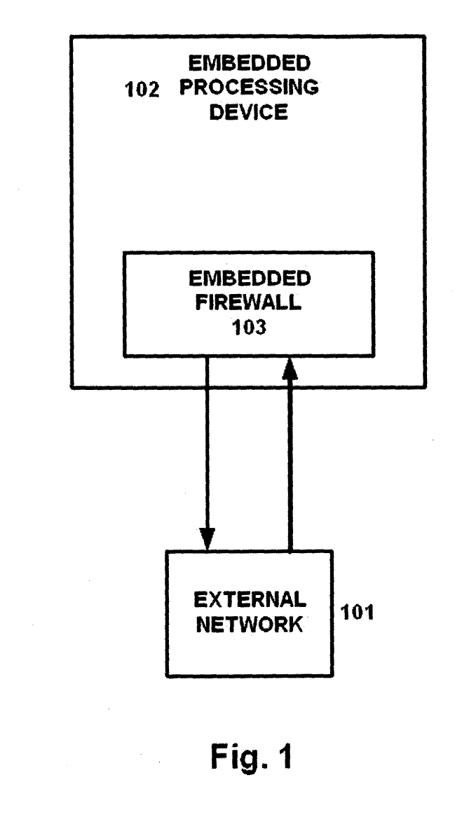

FIG. 1 illustrates an embedded processing system (“embedded device”) that is configured to utilize the present invention (“embedded firewall”). This device uses an embedded operating system and may or may not be portable (“mobile”). The embedded device may be connected to an external network either by hard wire or by radio frequency (“wireless”) communication.

As shown in FIG. 1, the embedded firewall 103 runs directly on the embedded device 102. The embedded device 102 communicates with the external network 101. However, all data communication between the embedded device 102 and the external network 101 must first pass through the embedded firewall 103. The embedded firewall 103 thus “stands guard” over all inbound and communication between the embedded device 102 and the external network 101.

The embedded device 102 communicates with the external network 101 with any number of protocols using either a wired or wireless connection or both. In any case, all data passing into or out of the embedded device 102 must first pass through the embedded firewall 103 for selective filtering.

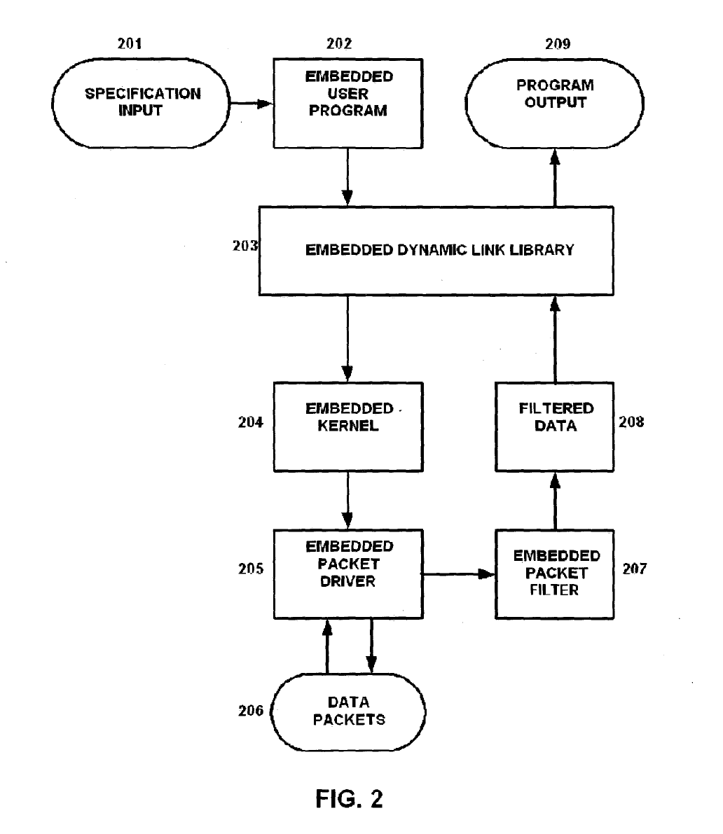

FIG. 2 illustrates how the present invention improves the protection of the embedded device described in FIG. 1.

The firewall specification is entered into the device at step 201. This specification will determine the selective filtering capability of the embedded firewall, namely, what specific communication is blocked and what is allowed to enter or leave the device. The specification may be entered, for example, either by interactive user input or by reading a file containing the specification.

After the specification is entered in step 201, the embedded user program compiles the specification into an optimized form for subsequent use by the “filtering engine” (the embedded packet filter in step 207). The user program at step 202 then passes the specification, along with any needed program parameters, to the embedded dynamic link library (DLL) at step 203.

The embedded DLL at step 203 acts as a mediator between the user level and the underlying embedded operating system kernel level. This allows the program to work in a platform-independent manner by isolating the user program from the underlying embedded packet driver and filter.

The embedded DLL at step 203 passes the compiled specification to the embedded operating system kernel at step 204. Meanwhile data packets are continually entering and leaving the embedded device from the external network at step 206, forming a communication that is controlled by the embedded packet driver at step 205. The embedded packet filter at step 207 interacts with the embedded packet driver at step 205 to selectively filter data packets based on the previously entered specification.

The embedded packet filter at step 207 outputs the resultant selectively filtered data at step 208. This filtered data is then reported back to the user level through the embedded DLL at step 203. The embedded DLL at step 203 acts as a mediator between the underlying embedded operating system kernel and the user level above it. This allows the embedded user program to work in a platform-independent manner by isolating it from underlying embedded kernel.

The embedded DLL at step 203 may send further filtering instructions to the embedded kernel at step 204, based on the results of the filtered data reported to it from step 208. In addition, the embedded DLL at step 203 reports the data filtering activity to the user level as program output in step 209.

The above description is included to illustrate the operation of the preferred embodiments, and is not meant to limit the scope of the invention. From the above discussion, many variations will be apparent to one skilled in the art that would yet be encompassed by the spirit and scope of the present invention.

The invention claimed is:

1. An apparatus configured to protect a computing device, said computing device including at least an embedded operating system, said apparatus comprising:
a. means for entering the desired filter specification at the user layer using an embedded user interface (UI) program or an imported specification file,
b. means for compiling the specification to be subsequently used by the embedded filtering engine,
c. means for using an embedded dynamic link library (DLL) as an intermediary to isolate the user program from the lower kernel level, thus providing a system-independent interface,
d. means for communicating the specification to the kernel layer using the embedded DLL,
e. means for monitoring packets in the kernel level as they enter from the lower network level using an embedded packet driver,
f. means for filtering packets at the kernel level using the embedded filtering engine and the previously defined filter specification,
g. means for reporting the results from the kernel level back up to the user level through the embedded DLL.

2. A method for protecting a host computer device, said computing device including at least an embedded operating system, comprising the steps of:
a. entering the desired filter specification at the user layer using an embedded user interface (UI) program or an imported specification file,
b. compiling the specification to be subsequently used by the embedded filtering engine,
c. using an embedded dynamic link library (DLL) as an intermediary to isolate the user program from the lower kernel level, thus providing a system-independent interface,
d. communicating the specification to the kernel level using the embedded DLL,
e. monitoring packets in the kernel level as they enter from the lower network level using an embedded packet driver,
f. filtering packets at the kernel level using the embedded filtering engine and the previously defined filter specification,
g. reporting the results from the kernel level back up to the user level through the embedded DLL.

3. The method of claim 2, wherein said multiple processes include protecting embedded devices.

4. The method of claim 2, wherein said multiple processes include protecting wireless embedded devices.

5. The method of claim 2, wherein said embedded firewall uses an embedded dynamic link library (DLL) as an intermediary to isolate the user program from the lower kernel level, thus providing a system-independent interface.

6. The method of claim 2, further including filtering packets at the kernel level using the embedded filtering engine and the previously defined filter specification

7. The method of claim 6, wherein results from the kernel level are reported back up to the user level.

8. The method of claim 6, further including using an embedded dynamic link library (DLL) as an intermediary when reporting results from the kernel level back up to the user level, thus providing a system-independent interface.

9. A method for selective filtering that includes protecting communication directly on embedded devices.

10. The method of claim 9, wherein the step of protecting communication directly on embedded devices is accomplished using a firewall.

11. The method of claim 9, the step of protecting communication directly on embedded devices is accomplished using selective filtering and includes protecting wireless communications directly on embedded devices.

12. The method of claim 9, further including: selectively filtering inbound communication directly on an embedded processing device

13. The method of claim 9, further including: selectively filtering outbound communication directly on an embedded processing device

14. The method of claim 9, further including: selectively filtering both inbound and outbound communication directly on an embedded processing device in a simultaneous manner.

15. The method of claim 9, further including: selectively filtering inbound wireless communication directly on an embedded processing device

16. The method of claim 9, further including: selectively filtering outbound wireless communication directly on an embedded processing device

17. The method of claim 9, further including: selectively filtering both inbound and outbound wireless communication directly on an embedded processing device simultaneously.

18. The method of claim 9, further including: using a packet filter driver specifically designed for embedded systems.

19. The method of claim 9, further including: filtering multiple protocols on the same embedded device.

20. The method of claim 9, wherein the step of protecting communication directly on embedded devices is accomplished by selectively filtering communication on an embedded processing device, said device including at least an embedded operating system, and further comprising the steps of: (a) entering the desired filter specification at the user layer using an embedded user interface (UI) program or an imported specification file, (b) compiling the specification to be subsequently used by the embedded filtering engine, (c) using an embedded dynamic link library (DLL) as an intermediary to isolate the user program from the lower kernel level, thus providing a system-independent interface, (d) communicating the specification to the kernel layer using the embedded DLL, (e) monitoring packets in the kernel level as they enter from the lower network level using an embedded packet driver, (f) filtering packets at the kernel level using the embedded filtering engine and the previously defined filter specification, (g) reporting the results from the kernel level back up to the user level through the embedded DLL.
